(19) United States
(12) Patent Application Publication
(10) Pub. No.: US 2007/0115261 A1
(43) Pub. Date: May 24, 2007

(54) Virtual Keyboard input system using three-dimensional motion detection by variable focal length lens

(75) Inventors: Gyoung Il Cho, Seoul (KR); Cheong Soo Seo, Seongnam (KR)

Correspondence Address: STEREO DISPLAY INC., 980 EAST ORANGETHORPE AVENUE, SUITE F, ANAHEIM, CA, 92801, US

(73) Assignees: Stereo Display, Inc., Anaheim, CA (US); Angstrom, Inc., Suwon (KR)

(21) Appl. No.: 11/286,971

(22) Filed: Nov. 23, 2005

(51) Int. Cl. G09G 5/00

(52) U.S. Cl. 345/168

(57) ABSTRACT

A virtual keyboard input system using three-dimensional motion detecting by variable focal length MMAL is provided. The compactness of the virtual keyboard input system is accomplished by the variable focal length MMAL performing three-dimensional imaging function. Since the three-dimensional imaging process occurs in a very short time scale, the system can determine the motion of the input by the user and track the motion of the user in real-time based response. Image processor can determine which input is occurred at the moment and the time-dependent profile of the motion itself. The input system gives an output just like a conventional keyboard and a mouse system.

### BACKGROUND OF THE INVENTION

As the computer related system develops, the need for new input device is also increasing. Until now, studies have shown that using a keyboard with/without mouse-like pointing device is the most efficient way to have an input from a user. Since mobile devices such as cellular phone and portable digital assistants (PDA) are too small, it can not have a full sized keyboard system inside. Some PDA's use handwriting recognition system or touch screen type keyboard display.

To solve the problem of portability, a method of data and commands input system is devised recognizing visual images of user actions that can be interpreted and converted to commands for a computer system. Korth proposed a method for such an input device in U.S. Pat. No. 5,767,842 and also Bamji proposed somewhat advanced technique in U.S. Pat. No. 6,323,942.

In Korth-type system, a conventional TV camera captures the movements of the fingers and by the signal processing process, it can determine the vertical motion of the fingers and finally gives the correct input to the computer. Since this type of detection should be accompanied by the detection of the contour of each finger using changes in luminosity of the detected light, the process is very difficult if the stray light exists or the surroundings are changed.

The three-dimensional imaging method using gated light source and detector proposed by Bamji uses time-gating pulses generated by the source, and array detector receives the reflected signal from user's fingers. The delay between the gated pulses from different fingers in different cells determines the motion of the fingers. This scheme needs a very fast signal detecting array and processing system to follow the speed of light down to sub nanosecond time scale.

To accomplish the virtual keyboard input device, a new three-dimensional motion detecting or tracking system is needed for a good performance.

### SUMMARY OF THE INVENTION

The objective of the present invention is to provide a virtual keyboard input device with three-dimensional motion detecting system. The system uses a variable focal length lens for embodiment of the three-dimensional imaging and motion detecting function. For this purpose, varying the focal plane of a variable focal length lens is a key role of the device, which is accomplished by a variable focal length micromirror array lens (MMAL). The three-dimensional imaging using MMAL was proposed in U.S. patent application Ser. No. 10/822,414 and 11/208,115. The three-dimensional imaging and motion detecting function are achieved by image processing on the two-dimensional images captured by the image sensors.

The image sensor takes two-dimensional images of user finger with different focal planes that are shifted by changing the focal length of the micromirror array lens. The image processing unit extracts in-focus pixels or areas from the two-dimensional images with different focal planes and generates an all-in-focus image. Three-dimensional information of the user finger can be obtained from the focal plane of each in-focus pixel. There are several methods for the image processing unit to obtain an all-in-focus image with depth information.

Since the changing of the focal length in the variable focal length MMAL is so fast, the real-time three-dimensional movements of the fingers can be detected. From the movements detected, the input can be obtained by the position and the movements of the fingers.

For the guide for user, the projection of the virtual device such as a keyboard can be projected to any surface. 2D projection system using MMAL was proposed in U.S. patent application Ser. No. 10/914,474 and 11/208,114. The projection unit projects a keyboard image on a flat plane. In addition, the projection unit projects a keyboard image on a surface with an arbitrary profile.

When this is applied, the keyboard is projected on a certain surface and the user can uses this image as a guideline for input just like a keyboard. Then the virtual keyboard input device detects the motion of the user and finally decides the input made by the user. In detecting process, the MMAL is used for varying the focal plane of the lens. Since the changes of the focal length of the MMAL is so fast that the real-time 3D imaging can be obtained. The processing unit calculates the position of the fingers and their movements, which can include the decision process of the action within the response time of the user.

The virtual keyboard input system also uses the three-dimensional tracking function for detecting the motions of the fingers. The system focuses its foci on the every finger and finds the position of the fingers. Then, the system follows the movements of the fingers by varying the focal length and/or optical axis of MMAL. Since the system can follow every finger of the user in real-time, it can obtain the time dependent movements of the fingers and can determine which input has been occurred. Optical Tracking System using MMAL was proposed in U.S. patent application Ser. No. 10/979,619.

The MMAL is described in U.S. Pat. Nos. 6,934,072 and 6,934,073 as well as U.S. application Ser. Nos. 10/855,554, 10/855,715, 10/857,714, 10/857,280, 10/983,353, 11/076,616, and 11/191,886.

The MMAL includes a plurality of micromirrors. The translation and/or rotation of each micromirror of the micromirror array lens are controlled to vary the focal length of the MMAL.

The array of micromirrors works as a reflective focusing lens by making all light scattered from an object converge into a focus point and meet periodic phase condition among the lights reflected by micromirrors.

In order to satisfy requirements as a variable focal length MMAL, the micromirrors are electrostatically and/or electromagnetically controlled by actuating components to have desired motions. The focal length of the lens is changed by controlling translation of micromirrors, by controlling rotation of micromirrors, or by controlling both translation and rotation of micromirrors.

MMAL can change its optical axis by controlling the rotation and translation of the micromirrors. An object which does not lie on the optical axis can be imaged by the MMAL without any macroscopic mechanical movement of the three-dimensional imaging system.

The virtual keyboard input system includes at least one reflective MMAL and at least one image sensor to get three-dimensional image. MMAL focuses the image of user finger onto the image sensor.

Different focusing geometry is possible for imaging the object onto an image sensor. MMAL makes an image by reflecting light from the object directly onto the image sensor. A beam splitter in the beam path can be used for forming a different geometry.

The lens has a large focal length variation with a fine depth resolution. The large focal length variation increases the space for user input and fine resolution of the focal length enhances selectivity of the motions and movements.

The MMAL has a high optical focusing efficiency. In addition, a large size lens is possible, the focusing system can be very simple, and the lens requires low power consumption. The lens has a low production cost because of the advantage of mass productivity. Electric circuits to operate the micromirrors can be replaces with conventional semiconductor technologies such as MOS and CMOS.

The MMAL used in present invention has the following advantages: (1) the MMAL has a very fast response time thanks to the tiny mass of the micromirror; (2) the lens has compactness in size suitable for a cellular phone or other mobile applications; (3) the lens has a large focal length variation because large numerical aperture variations can be achieved by increasing the maximum rotational angle of the micromirror; (4) the lens has a high optical efficiency; (5) the lens can have a large size aperture without losing optical performance since the MMAL includes discrete micromirrors, the increase of the lens size does not enlarge the aberration caused by the shape error of a lens; (6) the cost of production is inexpensive because of the advantage of mass productivity of microelectronics manufacturing technology; (7) the lens compensates for aberration; (8) the lens makes the focusing system much simpler; (9) the lens requires small power consumption when electrostatic actuation is used to control it.

The invention of the virtual keyboard input system using three-dimensional motion detection by variable focal length MMAL has the following advantages: (1) the system detects a real-time three-dimensional motions; (2) the system follows and tracks the action of the user; (3) the system tracks the each position of user finger simultaneously; (4) the system has a large user input space since the system has a large range of focal plane; (5) the system has a high depth resolution; (6) the cost of production is inexpensive because the MMAL is inexpensive; (7) the system has a high optical efficiency; (8) the system compensates for aberration; (9) the system is very simple because there is no macroscopic mechanical displacement; (10) the system is compact and suitable for the mobile devices; (11) the system requires small power consumption since the MMAL is actuated by electrostatic force.

Although the present invention is brief summarized herein, the full understanding of the invention can be obtained by the following drawings, detailed description, and appended claims.

### DESCRIPTION OF THE FIGURES

These and other features, aspects, and advantages of the present invention will become better understood with reference to the accompanying drawings, wherein:

FIG. 1 is a schematic diagram showing components of the virtual keyboard input system and how the virtual keyboard input system using three-dimensional imaging works.

FIG. 2 is a schematic diagram showing the method for finding time-dependent point change by the variable focal length MMAL and imaging unit.

FIG. 3 shows the principle of the MMAL.

FIG. 4 is a schematic plane view showing the structure of the lens that is made of many micromirrors and actuating components.

FIG. 5 is a schematic diagram showing how a MMAL works as a lens.

FIG. 6 shows two degrees of rotational freedom and one degree of translational freedom of the micromirror.

### DETAILED DESCRIPTION OF THE INVENTION

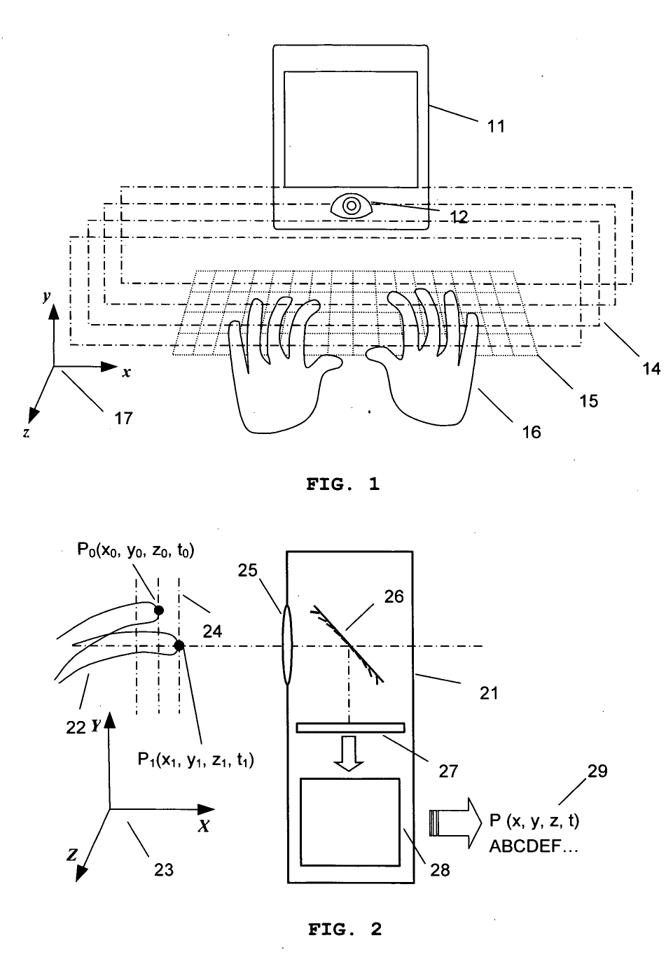

FIG. 1 shows a schematic diagram for the virtual keyboard input system using three-dimensional motion detection by variable focal length MMAL. The first requirement of the small mobile device 11 is compactness. Since the virtual keyboard input system projects a keyboard image 15, no space for the input device is necessary. The input system 12 has a variable focal length MMAL for detection of the three-dimensional movement of the user 16. The input system 12 gathers the information on the motions in three-dimensions by three-dimensional imaging method using the variable focal length MMAL. The three-dimensional imaging using the variable focal length MMAL was proposed in U.S. patent application Ser. No. 10/822,414. The three-dimensional imaging method obtains the depth 14 and in-plane position information of user 16 motion. Once the information is collected, the motion can be described as a time dependent movement in three-dimensional coordinate system 17. With the time dependent motion, the system determines which input action is occurred by the user. Then the system gives the correct input to the computer based mobile device 11.

Independently, the system has a two-dimensional projection system for guiding the input of the user. This projection system projects a keyboard image 15 or some other guidelines to help the user performing proper action in proper space. The 2D projection system using MMAL was proposed in U.S. patent application Ser. No. 10/914,474 and 11/208,114.

FIG. 2 is a schematic diagram showing the method for finding time-dependent change of the point by the variable focal length MMAL and imaging unit. The virtual keyboard input system 21 has a variable focal length MMAL 26. The motion of user 22 from P₀(x₀, y₀, z₀, t₀) to P₁(x₁, y₁, z₁, t₁) in real coordinates 23 is captured by the two-dimensional image sensor 27. The three-dimensional imaging and motion detecting function are achieved by image processing about the two-dimensional images captured by the image sensors. The image sensor takes two-dimensional images of user finger with different focal planes that are shifted by changing the focal length of the MMAL. The image processing unit 28 extracts in-focus pixels or areas from the two-dimensional images with different focal planes 24 and generates an all-in-focus image. Three-dimensional information 29 of the user finger can be obtained from the focal plane of each in-focus pixel. There are several methods for the image processing unit to obtain an all-in-focus image with depth information.

The input system generates a time-dependent motion data of the user and gives the proper action commands to the computer based device with respect to the motions of the user.

The input system gives keyboard input to the computer based device by recognizing the motion of user fingers.

A pointing tool can be used for indicating the three-dimensional position. The pointing tool can be any object which can be imaged in the image sensor.

The fast response of the MMAL enables the process for finding the focus of the pointing tool instantaneous. Image processing unit processes the taken two-dimensional image to determine whether the object image lies on the focus or not. The tracking of the pointing tool can be accomplished by the fast response of the MMAL.

The user can use his/her finger as a pointing tool.

The input system gives an output just like the conventional keyboard does.

The output of the input system can be serial, PS/2, or USB type signal.

The input system gives an output of a pointing action. The output of the pointing action is time-dependent three-dimensional position.

Since the changing of the focal length in the variable focal length MMAL is so fast, the real-time three-dimensional movements of the fingers can be detected. The input can be obtained by the position and the movements of the fingers. The input system generates a time-dependent motion data of the user. The auxiliary lens 25 can be applied for improving imaging performance such as better numerical aperture and focusing power of variable focal length MMAL 26.

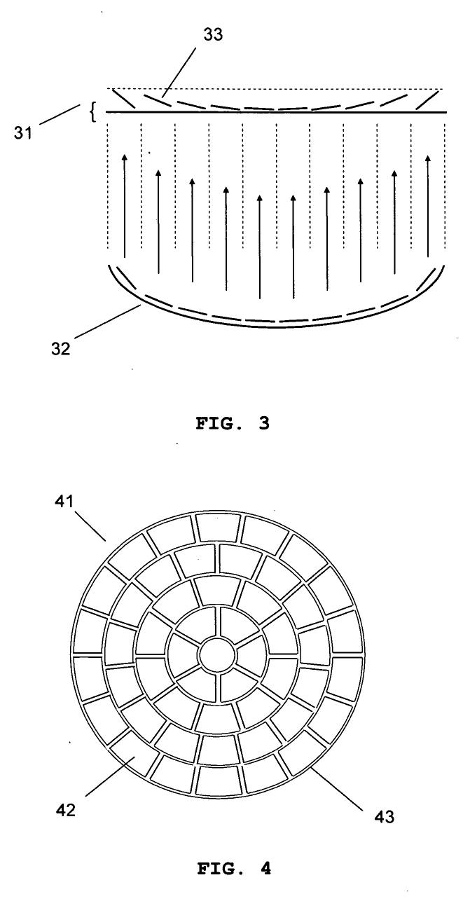

FIG. 3 shows the principle of a MMAL 31. Two conditions should be satisfied to build a perfect lens. One is a converging condition that all light scattered by one point of an object should converge into one point of the image plane. The other is the same phase condition that all the converging light at the image plane should have the same phase. To satisfy the perfect lens conditions, the surface shape of conventional reflective lens 32 reflects all the incident light scattered from one point of an object to the other one point on the image plane with the same optical path length traveled. Thanks to the periodicity of the light phase, the same phase condition can be satisfied even though the optical path length of the converging light is different. When the difference of the optical path length is exactly the same as the multiples of the wavelength, the reflected beam at the focus meets the phase condition. Therefore, the surface shape of the conventional reflective lens 32 satisfying perfect lens conditions can be replaced by rotation and translation of micromirrors. Each micromirror 33 rotates to converge into focal point and translates to adjust the phase between the reflected lights from different micromirrors 33.

FIG. 4 illustrates the two-dimensional view of a MMAL 41. Each micromirror 42 of the MMAL 41 is controlled by electrostatic and/or electromagnetic force made by actuating components 43. The mechanical structures upholding each micromirror and the actuating components to rotate and translate the micromirrors 42 are located under the micromirrors 42 so that the micromirrors 42 have larger active area.

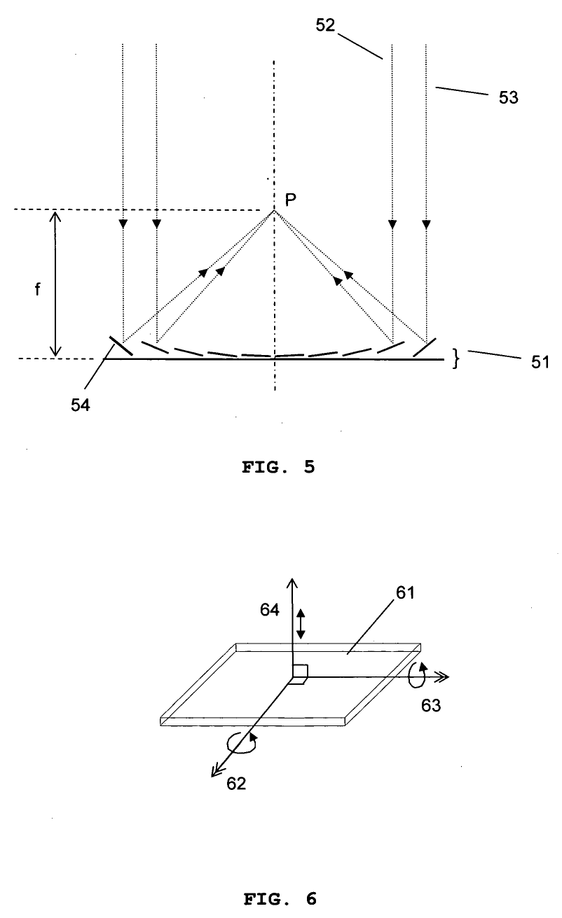

FIG. 5 illustrates how the MMAL 51 makes an image. Arbitrary scattered lights 52, 53 from the object are converged into one point P on the image plane by controlling the position of each of the micromirrors 54. Phases of individual lights 52, 53 can be adjusted to have the same value by translating each of the micromirrors 54. The required translational displacement is at least half of the wavelength of light.

The focal length f of the MMAL 51 is adjustable by controlling the rotation and/or translation of the micromirror 54. The operation of the MMAL 51 is possible by controlling only rotation regardless of the phase condition. In this case, the quality of the image generated by the MMAL is degraded because of aberration. Also translation only without rotation can form a Fresnel diffraction lens with aberration. The smaller the sizes of the micromirrors 54 can reduce aberration. Even though the focusing ability by either rotation or translation is not powerful, the lens with one degree of freedom in motion has the advantage of simple control and fabrication.

FIG. 6 shows two degrees of rotational freedom and one degree of translational freedom of the micromirror 61. The array including micromirrors 61 with two degrees of rotational freedom 62, 63 and one degree of translational freedom 64, which are controlled independently can make a lens with arbitrary aspheric surface. Incident lights can be modulated arbitrarily by forming an arbitrary aspheric surface. To do this, it is required that incident lights are deflected to an arbitrary direction by controls of two degrees of rotational freedom 62, 63. Independent translation 64 of each micromirror is also required to satisfy the phase condition.

While the invention has been shown and described with references to different embodiments thereof, it will be appreciated by those skills in the art that variations in form, detail, compositions and operation may be made without departing from the spirit and scope of the invention as defined by the accompanying claims.

What is claimed is:

1. A virtual keyboard input system comprising
(a) a three-dimensional imaging system comprising at least one MMAL and at least one two-dimensional image sensor, wherein the focal length of MMAL is controlled to change focal planes of the three-dimensional imaging system.
(b) a processing unit, wherein the processing unit extracts input information.

2. The virtual keyboard input system of claim 1, wherein the system comprises a 2D projection system, wherein the 2D projection system projects an image of input device.

3. The virtual keyboard input system of claim 2, wherein the projection unit comprises MMAL.

4. The virtual keyboard input system of claim 2, wherein the image of input device is that of a keyboard.

5. The virtual keyboard input system of claim 2, wherein the projection unit projects an image of input device on a plane.

6. The virtual keyboard input system of claim 2, wherein the projection unit projects an image of the input device on a flat surface.

7. The virtual keyboard input system of claim 2, wherein the projection unit projects an image of the input device on a surface with an arbitrary profile.

8. The virtual keyboard input system of claim 1, wherein the input system finds the position of user input.

9. The virtual keyboard input system of claim 8, wherein the position of the user input is decided by the focal plane of the MMAL and the two-dimensional image taken by the image sensor.

10. The virtual keyboard input system of claim 1, wherein the input system obtains the motion information of the user.

11. The virtual keyboard input system of claim 10, wherein the input system tracks the motion of the user.

12. The virtual keyboard input system of claim 10, wherein the input system generates a time-dependent motion data of the user.

13. The virtual keyboard input system of claim 10, wherein the input system obtains motion information of the user in real-time scale.

14. The virtual keyboard input system of claim 10, wherein the input system gives the proper action commands to the computer based device with respect to the motions of the user.

15. The virtual keyboard input system of claim 10, wherein the input system gives keyboard input to the computer based device by recognizing the motion of user fingers.

16. The virtual keyboard input system of claim 1, wherein a pointing tool is used for indicating the three-dimensional position.

17. The virtual keyboard input system of claim 16, wherein the pointing tool is imaged by the image sensor.

18. The virtual keyboard input system of claim 16, wherein the user can use his/her finger as a pointing tool.

19. The virtual keyboard input system of claim 4, wherein the input system gives an output just as the conventional keyboard gives.

20. The virtual keyboard input system of claim 19, wherein the output of the input system can be serial, PS/2, or USB type signal.

21. The virtual keyboard input system of claim 1, wherein the input system gives an output of a pointing action.

22. The virtual keyboard input system of claim 21, wherein the output of the pointing action is time-dependent three-dimensional position.

23. The virtual keyboard input system of claim 1, wherein the MMAL compensates aberration of the 3D imaging system.

24. The virtual keyboard input system of claim 1, wherein the micromirrors of MMAL are controlled independently.

25. The virtual keyboard input system of claim 1, wherein the micromirrors have two degrees of rotational freedom and one degree of translational freedom.
